(19) United States
(12) Patent Application Publication
(10) Pub. No.: US 2015/0026616 A1
(43) Pub. Date: Jan. 22, 2015

(54) Method and Apparatus for Simple Presentation and Manipulation of Stored Content

(71) Applicant: Nubo Software Ltd., Airport City (IL)

(72) Inventors: Anat Litan Sever, Kiryat Ono (IL); Israel Lifshitz, Ganei Tlkva (IL); Asi Mugrabi, Bat-Yam (IL)

(21) Appl. No.: 14/337,809

(22) Filed: Jul. 22, 2014

Related U.S. Application Data
(60) Provisional application No. 61/856,856, filed on Jul. 22, 2013.

(51) Int. Cl. G06F 3/0481; G06F 3/0484; G06F 3/0488; G06F 3/01

(52) U.S. Cl. CPC G06F 3/04817; G06F 3/017; G06F 3/04842; G06F 3/04845; G06F 3/0488
USPC 715/765

(57) ABSTRACT

A method and apparatus for manipulating and moving stored electronic content in a device. A display and a user interface are provided that allow a user of a simple and limited resource (e.g., mobile) device to interact with breadcrumb graphical representations of stored information objects (e.g., files, folders) and to move a selected object from one level to another in a multi-level hierarchy of stored information objects in a single active application window. In some aspects, a touch-sensitive display is provided that allows the user to move an object from one location to another with a single (e.g., drag) gesture, even moving the selected object up and down through a directory structure without the need for multiple windows to be presented to the user to do so.

### TECHNICAL FIELD

The present disclosure generally relates to handling of stored content in devices with limited resources. More specifically, to the moving of content such as a file or a folder between locations in a mobile electronic device using simple compact gestures that still allow movement of the content between at least a first and a second level in a multilevel hierarchy of stored content.

### RELATED APPLICATIONS

The present application is related to and claims priority under 35 USC §120 to U.S. Provisional Application No. 61/856,856 having the same title herewith, filed on Jul. 22, 2013, which is hereby incorporated by reference.

### BACKGROUND

It is known that electronic content and media may be preserved in digital storage devices such as computer memory devices. The information stored in digital form on such devices is commonly kept in file and folder structures, which organize the information into logical and discrete portions. To access and manipulate the stored information a user uses a user interface built into an operating system of the device in order to create, edit, delete or move files and folders as desired. Graphical user interface operating systems allow users to interact with the stored content on their devices using a visual presentation provided on a display screen and accepting input from the user through a user input device such as a keyboard or a computer mouse. A user may manipulate or move content stored on the device by dragging or otherwise affecting an icon of the stored file or folder as needed.

FIG. 1 illustrates a file represented by an icon 102 graphically located within a folder 100 (John). Another folder 104 (Mary) contains no files, but a user may wish to move file 102 from the first folder 100 to the second folder 104. FIG. 2 illustrates the result of moving file 102 from folder 100 to folder 104. The examples of FIGS. 1 and 2 are taken from the Apple Mac OS operating system and represent screenshots from the display of such a computer running the Apple Mac OS. The folders 100 and 104 may be logically related to one another in a hierarchal sense, meaning that one of the folders may be nested within or hierarchically beneath the other. Other representations of hierarchical data storage schemes are also possible and will be mentioned below. It is noted that user interfaces such as those shown in FIG. 1 and FIG. 2, which also include the windows graphical interface from Microsoft, permit multiple windows to be displayed at the same time on a display screen. That is, the display screen presents a representation of the contents folder 100 and folder 102 separately on the multi-window user interface display. The ability to display multiple windows representing multiple folder locations on a single screen as in FIG. 1 and in FIG. 2 is in part possible because modern computers have sufficient computer resources (memory, processor speed) to allow such simultaneous rich environments to be displayed to a user. Simpler or lesser equipped devices may not be capable of such rich multi-window user interface displays and may be limited in their ability to simultaneous present a user with representations of stored files and directories.

The Apple iOS mobile device operating system includes a user interface that permits a user to drag an object (e.g., an app icon) from one group of objects (like a folder) to another using a touch-hold-drag movement on the device screen. However, this system is limited to moving icons from one folder to another and does not permit multilevel (hierarchical) folder systems with a plurality of levels of the hierarchy nested within one another.

FIG. 3 illustrates another graphical user interface provided by Google Drive. The user interface 200 includes a column graphically listing folders and directories 202 on the left hand side. The directories 202 may be hierarchically related to one another as a directory tree and may show a folder disposed within another folder, even if this is merely a representation of the actual physical means of storing the content on the users computer. A list of files such as file 206 may be related to a given folder 208 as represented by arrow 204.

As mentioned earlier, as user of such prior art computer use interfaces may manipulate and organize information on a computer by clicking, dragging using a mouse, or copying and pasting a graphical icon of a file such as 102 or 206 so as to move it from one logical or physical location on the computer to another. However, in these examples, multiple folder windows corresponding to multiple directories must be open and supported and represented on the user interface as in FIG. 1 and FIG. 2 and as in the windows operating system. Or alternatively, a complex directory tree structure must be supported and displayed on the device to allow for convenient and visually comprehensible manipulation of the contents of the device. The complexity and sophistication as well as the required graphical and pixel count needed to support multi-window user interface displays and directory tree structures is generally not available on smaller mobile devices having more limited computing resources and graphical display capabilities. Accordingly, the user interfaces of FIGS. 1-3 are not well suited for small mobile electronic devices such as cellular phones, personal digital assistants, and similar handheld electronics.

### SUMMARY

The present disclosure generally relates to handling of stored content in devices with limited resources. More specifically, to the moving of content such as a file or a folder between locations in a mobile electronic device using simple compact gestures that still allow movement of the content between at least a first and a second level in a multilevel hierarchy of stored content.

One aspect hereof is directed to a method for representing information in a mobile electronic device having a single-window user interface capable display, the method comprising organizing a plurality of information objects stored in said mobile electronic device according to a multi-level hierarchy, whereby each of said information objects occupies some level in said hierarchy; presenting on said display, in said single-window user interface, an inline series of graphical icons, each icon representing a corresponding one the group of information objects, and arranging each of the icons on said display according to its object's level in said hierarchy; and using a single gesture by a user, whereby said gesture comprises a user interaction with a surface of said display, selecting a selected one of said information objects by way of its graphical icon, and translating the graphical icon of said selected information object in a movement corresponding to said user's gesture, thereby moving the icon of said selected information object from a first level in said hierarchy to a second level in said hierarchy.

Another aspect is directed to a mobile electronic device having a graphical display unit, data storage unit and processing unit, the device comprising said data storage unit that stores a plurality of information objects in a multilevel hierarchical structure; said graphical display unit comprising an interactive screen that presents graphical representations of stored information objects and that responds to interactive gestures of a user and affects a status of information on said device responsive thereto; and; said processing unit that executes machine readable instructions including instructions to present a graphical user interface on said graphical display, and that executes machine-readable instructions to accept user interface inputs from a user of said device through said graphical display unit including accepting signals responsive to a single user interface gesture translate a graphical icon of a selected information object displayed on said graphical display in a movement corresponding to said user's gesture, thereby moving the icon of said selected information object from a first level in said hierarchy to a second level in said hierarchy and displacing data stored in said data storage unit corresponding to said movement of said icon.

Therefore, this application describes a method and apparatus for manipulating and moving stored electronic content in a device. A display and a user interface are provided that allow a user of a simple and limited resource (e.g., mobile) device to interact with breadcrumb graphical representations of stored information objects (e.g., files, folders) and to move a selected object from one level to another in a multilevel hierarchy of stored information objects. In some aspects, a touch-sensitive display is provided that allows the user to move an object from one location to another with a single (e.g., drag) gesture, even moving the selected object up and down through a directory structure without the need for multiple windows to be presented to the user to do so.

### BRIEF DESCRIPTION OF THE DRAWINGS

For a fuller understanding of the nature and advantages of the present concepts, reference is made to the following detailed description of preferred embodiments and in connection with the accompanying drawings, in which:

FIGS. 1-3 illustrate user interfaces in a display for moving files and folders and presenting the same to a user in various operating systems according to the prior art;

FIGS. 4-6 illustrate an exemplary display and user interface and movement of a selected file from one level of a stored content hierarchy to another;

FIG. 7-15 illustrate an exemplary display and user interface and details of an act of moving content from one level of a hierarchy of stored information objects to another, including how a single window displays and permits such movement;

FIG. 16 illustrates a logic flow diagram for a system and method as disclosed in some embodiments herein;

FIG. 17 illustrates an exemplary view of objects in an application including a bread crumb view and a file grid view of electronic objects;

FIG. 18 illustrates exemplary modules and components according to a system for performing the present methods; and

FIGS. 19-21 illustrate exemplary methods for carrying out scenarios according to the present invention.

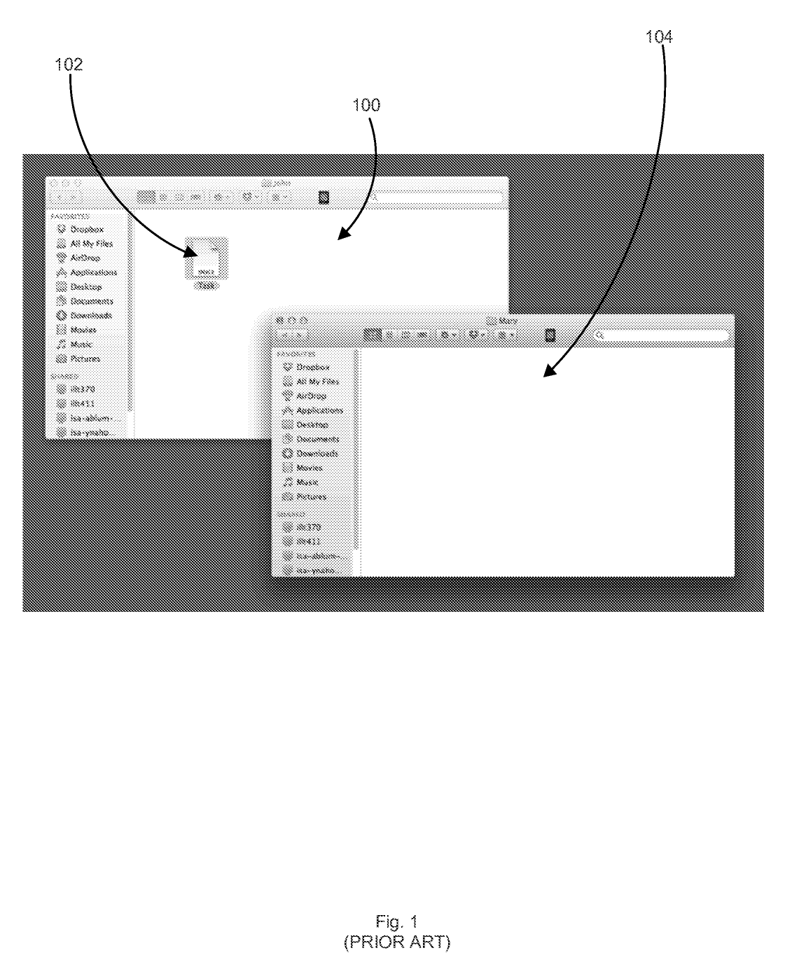

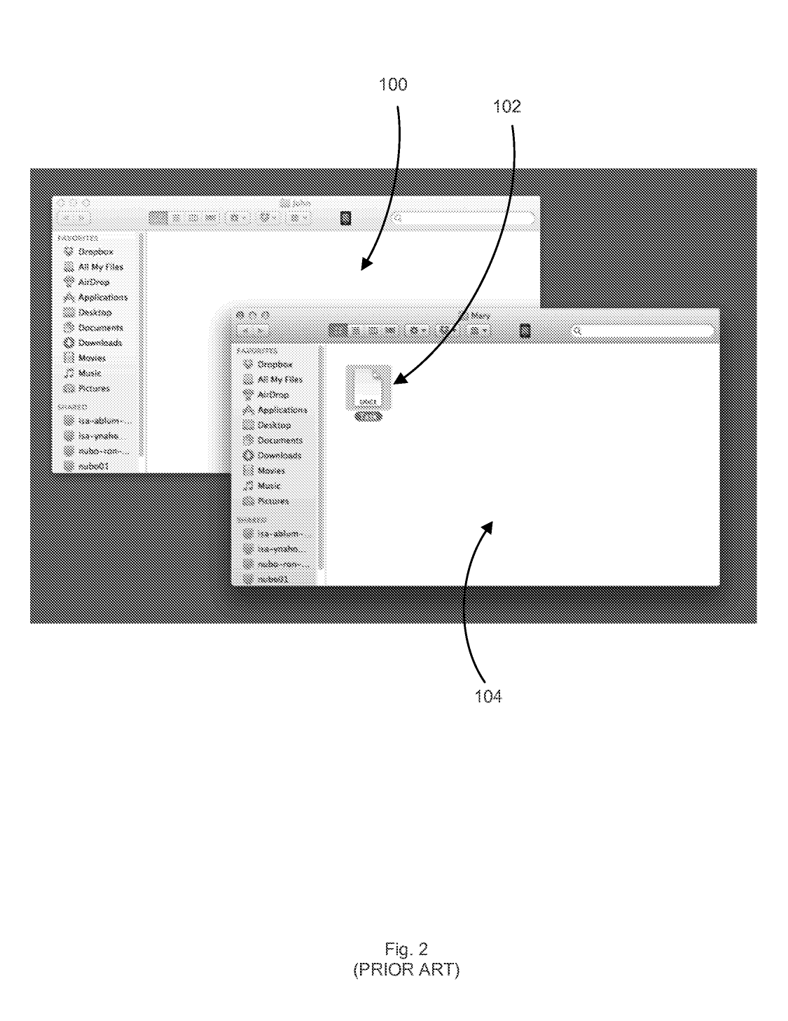

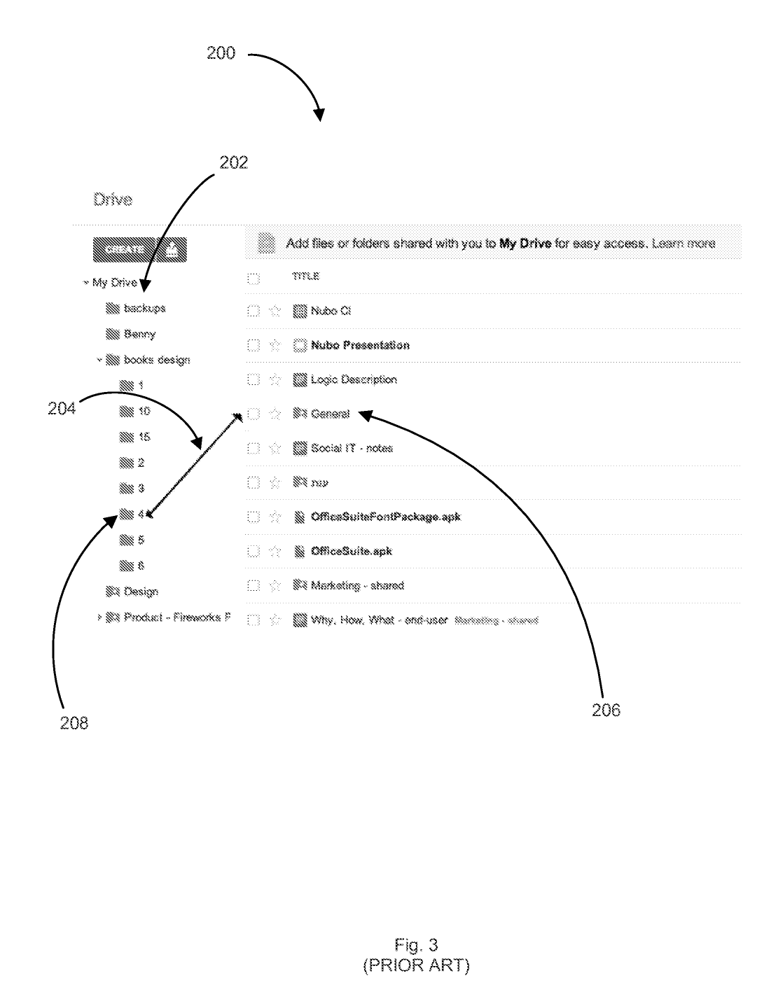

### DETAILED DESCRIPTION

As discussed above, the prior art is limited in its ability to navigate and manipulate stored objects (files, folders) on mobile type devices with single screen user interfaces (e.g., smart phones, tablets). One such limitation is that the prior systems cannot effectively navigate and move objects around a multilevel hierarchically organized file system having a plurality of levels of the file system. Among other aspects, the present invention enables such easy and intuitive navigation and movement of objects in such a multilevel hierarchical system on a device with limited computing and user interface resources. In a specific example, executed on a smart phone or similar device, the present invention enables viewing objects such as files in a multilevel hierarchy of folders, and further, enables a user with a single gesture (timed click and drag) to move a selected item from a given level in said hierarchy through an arbitrary number of other levels of the hierarchy (laterally and vertically through the hierarchy). This sophisticated capability has not been able prior to the present invention.

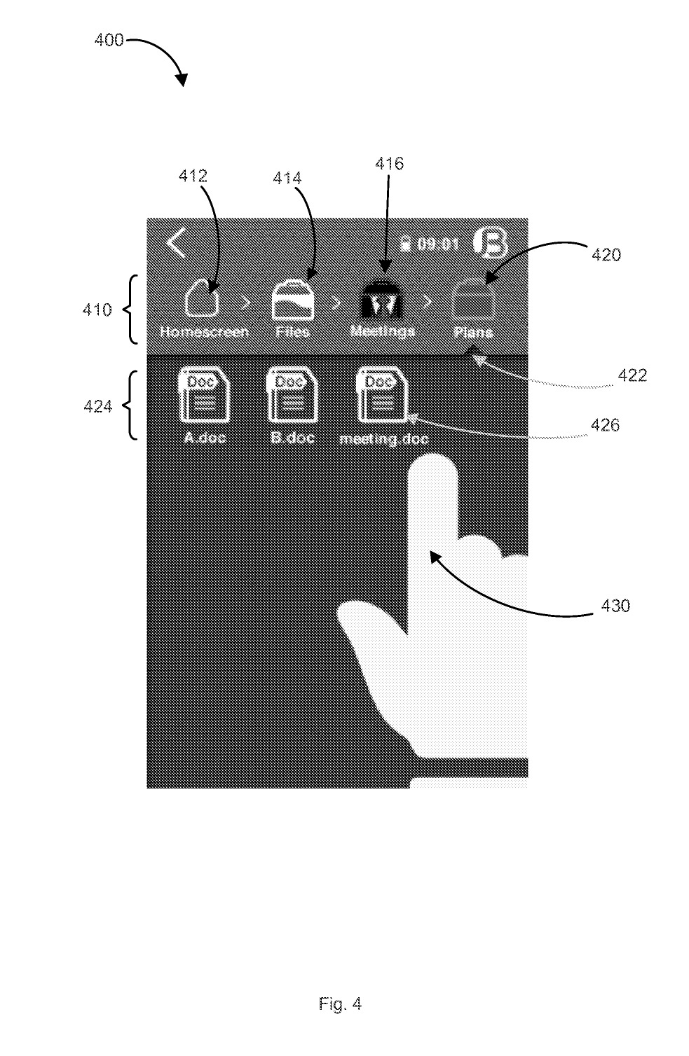

Referring to FIG. 4 and the following description we provide an exemplary embodiment describing the movement of a file 426 called “meeting.doc” from a folder 420 called “Plans” into a folder 416 called “Meetings all in one simple effective gesture by a user on a device touch-sensitive screen in a small screen device so that the actions are all visible in a single active application window. FIG. 4 illustrates a user interface 400 according to the present invention. The user interface 400 is visually displayed on a display screen in a portable or mobile electronic device such as a smart phone. The display screen may be a touch sensitive screen allowing for user input by touching or moving the users finger or a stylus pen across the screens surface. The user interface 400 specifically displays a single-window user interface as shown and a plurality of graphical indications and icons may appear on the screen.

In this example, which is only provided by way of illustration, a hierarchy of directories or folders are presented inline 410 near the top of the user interface 400. For example, a home screen 412 is higher in the hierarchy than the folder named Files 414, which is above the folder named Meetings 416 which in turn higher in the hierarchy than the folder named Plans 420. In the example shown, the lowest level of the hierarchy containing the folder Plans 420 is indicated by some graphical arrow 422 or other means so as to display the contents of directory 420 in the space below at 424. A user may place his or her hand or finger or pointer or stylus pen 430 onto the surface of the display to interact with the selected one of the files 424. Therefore, by touching a specific file such as meeting.doc 424 the user may affect the status of this file or its location in the directory structure 410.

In some instances, the graphical representations for the stored content or information objects can be represented as “breadcrumbs” that allow a user to see and easily manipulate the objects. The objects can be grouped into “containers” and a variety of types of media and data and information can be included therein as would be appreciated by those skilled in the art.

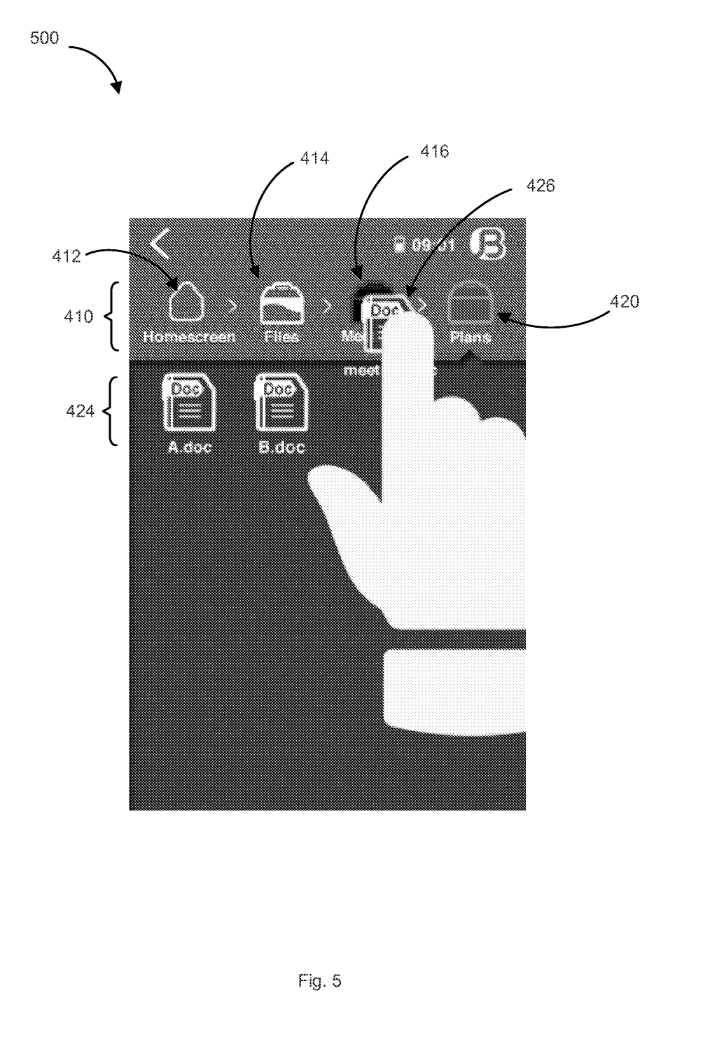

FIG. 5 illustrates an example of a graphical user interface 500 on a mobile electronic device as described above, where the user applies a gesture to move a selected one 426 of the files 424 into a selected destination folder 416 of the folders 410 of inline hierarchy above. The inline representations 410 are examples (but not limiting of) the Breadcrumb views, and the objects below that in the same active application screen 500 are Grid views in a preferred aspect. The user specifically touches on a graphical representation or icon representing a file 426 and moves this icon by translating or dragging his finger or stylus onto the folder meetings 416. The user touches or clicks on file 426 for a predetermined amount of time to trigger a long-click or holding selection gesture (e.g., by continuously holding the screen at coordinates of file 426 icon for over one second). Note that the file 426 was moved from one level in the hierarchy 410 (the folder named plans 420) to a higher level in the hierarchy (the folder named meetings 416). Accordingly, by a single gesture the user can move a file from one level in the hierarchy of folders and directories on the mobile device to another level in said hierarchy.

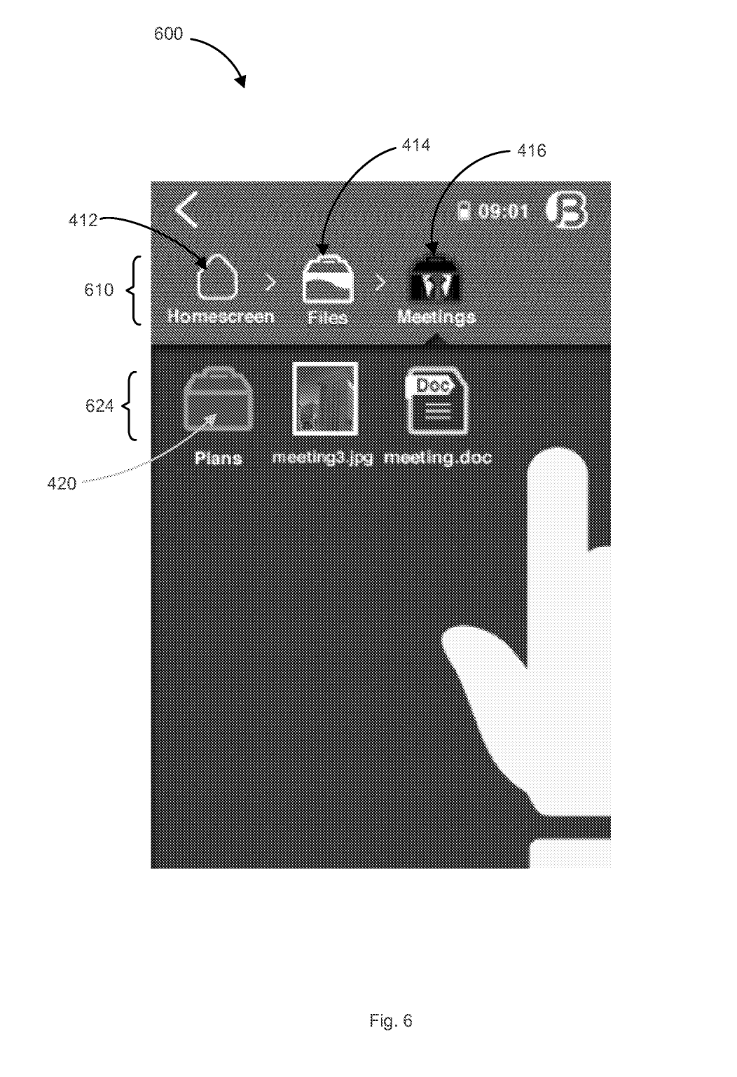

FIG. 6 illustrates a user interface display 600 where the directory Meetings 416 is selected so as to present on the single-window user interface what is inside this directory. The contents directory 416 are displayed in a group 424 and they include the folder named Plans 420 as well as other files or multimedia objects stored in the directory 416.

We next illustrate an example where a user moves a folder (containing several electronic files or items) into another level of a file directory hierarchy using a single gesture by the user on a small-screen mobile device. The size of such a small screen may be for example under 6 inches diagonally, or similar to many current smart phone screens. The operating system used to operate the mobile device as shown can be one of the several common mobile operating systems (iOS, Android, Windows, etc.) adapted with new software apps to allow the present display and user interactivity. Alternatively, a new operating system can be provided or emulated so that the device's operation natively supports the illustrated kinds of behaviors.

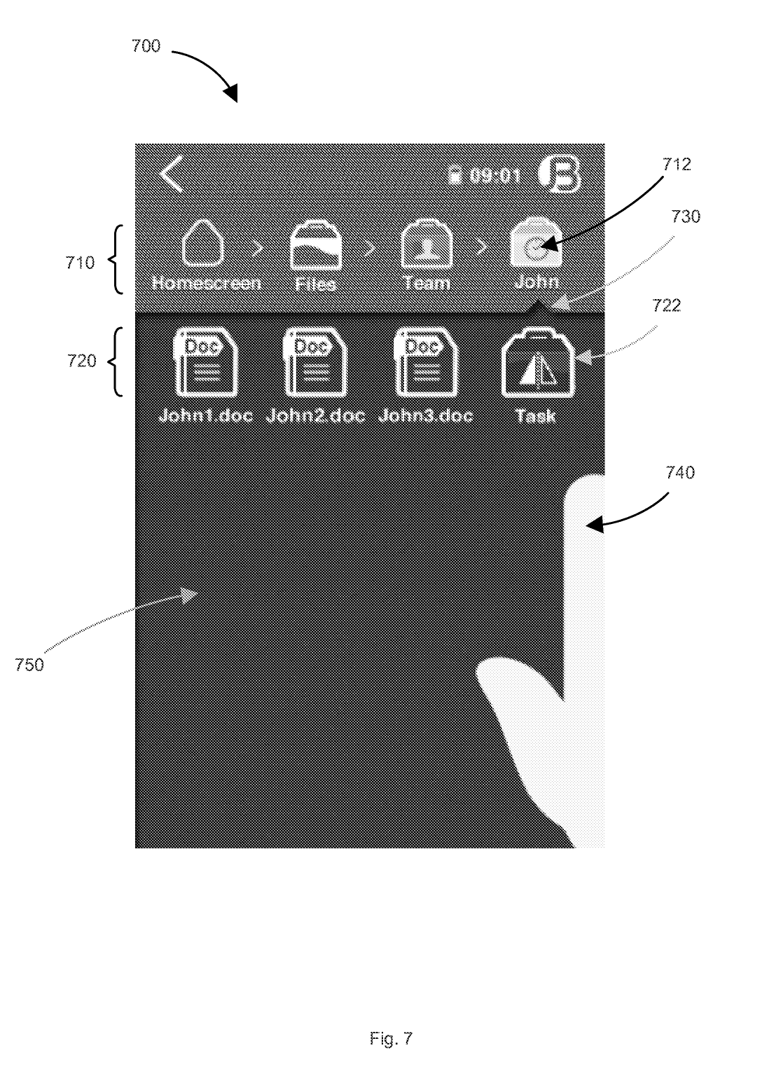

FIG. 7 illustrates an exemplary user interface display 700. The display may include a flat touch sensitive glass or similar display 750 that accepts inputs from a user such as tapping, swiping, dragging or multi-touch input gestures (e.g., pinching). Also, the display can provide interactivity through the use of a mechanical or electronic stylus. For clicking and dragging operations a user can use his or her fingertip 740 to apply pressure to the relevant parts of the surface of display 750.

As shown, there are a number of files and folders stored in the device that are represented on display 750. The visual output on display 750 is the result of electronically-stored and processed information (data) including data controlling the operation of video output so as to generate the needed icons of the folders and files.

An inline representation of a multilevel hierarchy of content 710 shows a highest level (Homescreen) containing another folder at a next-lower level (Files), which in turn contains another folder (Team) and within that another folder for a team member (John) 712. A tab, detent or other indicator 730 shows the contents of folder 712 (John). We see that the folder 712 (John) includes several items 720, represented on a separate row of the display 750. Three files (Joh1.doc, John2.doc, John3.doc) are present as well as a folder 722 (Tasks) associated with John. These items may be physically stored according to their level in hierarchy 710, or they may be stored in some other method appropriate for the operating system so that they are indexed or logically represented as shown. For all intents and purposes the contents of the folders in the multilevel hierarchy manifest themselves to a user as shown, at least logically or conceptually.

Now, to illustrate the present method and system, the user will act on the system to move a selected folder (the same can be applied to a file) into a different level of the hierarchy 710 than the one it originally resides. Again, in a preferred aspect this takes place using a simple single user action on the touch sensitive screen of the device and allows movement of stored objects within a single application screen environment or interface even if the movement includes moving an object through multiple levels of a plurality of levels of nested folders.

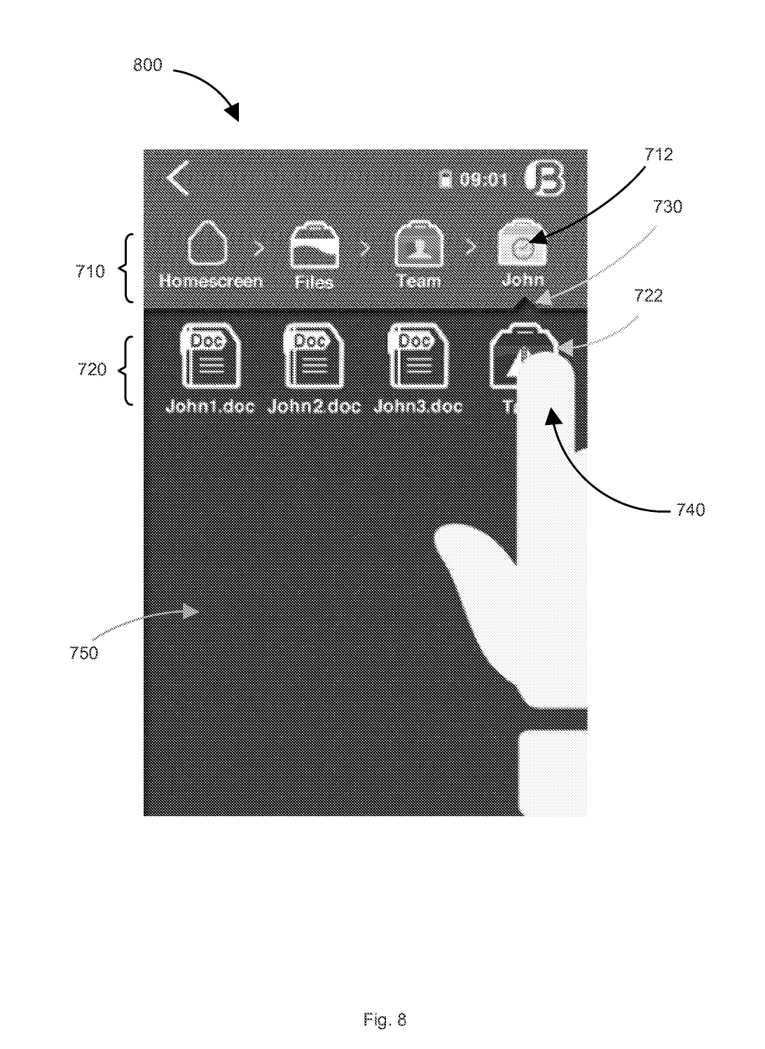

FIG. 8 illustrates a user putting his or her fingertip 740 on a selected item (e.g., folder 722) of the folder 712 (John) to move this folder 722 to some other level in the hierarchy 710. In some embodiments, the user must press and hold or touch the selected item 722 for a predetermined period of time to confirm its selection. In other embodiments, the appearance of the item 722 or some other user interface feedback (sound, visual) confirms to the user that he/she has indeed made a selection of the selected item and that it is ready for opening the selected folder.

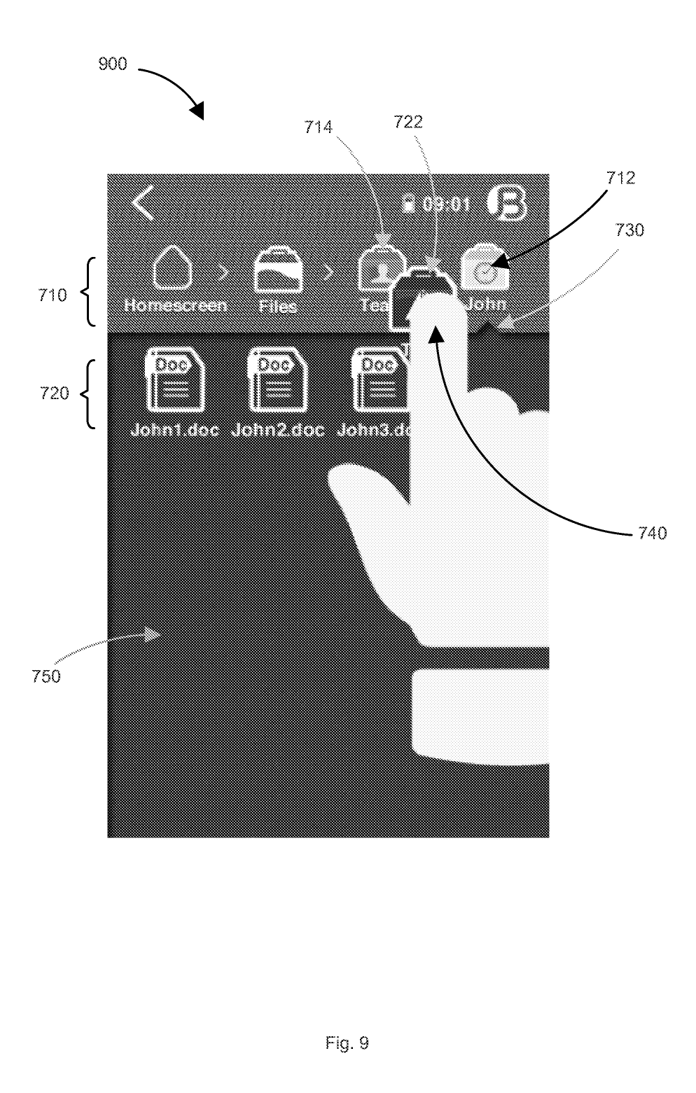

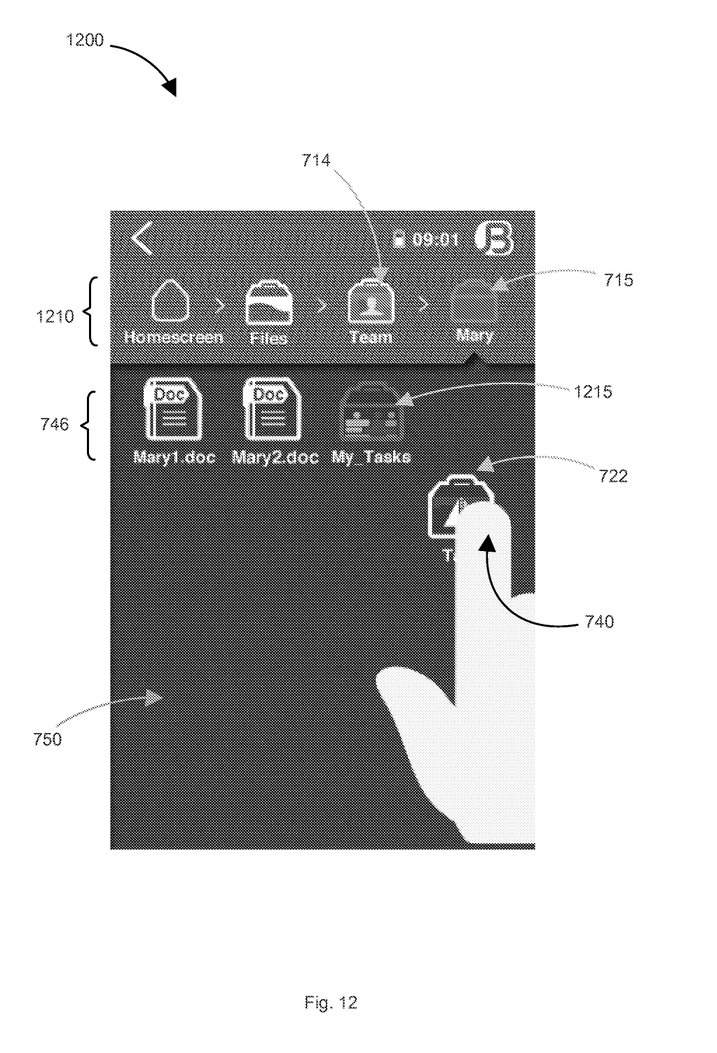

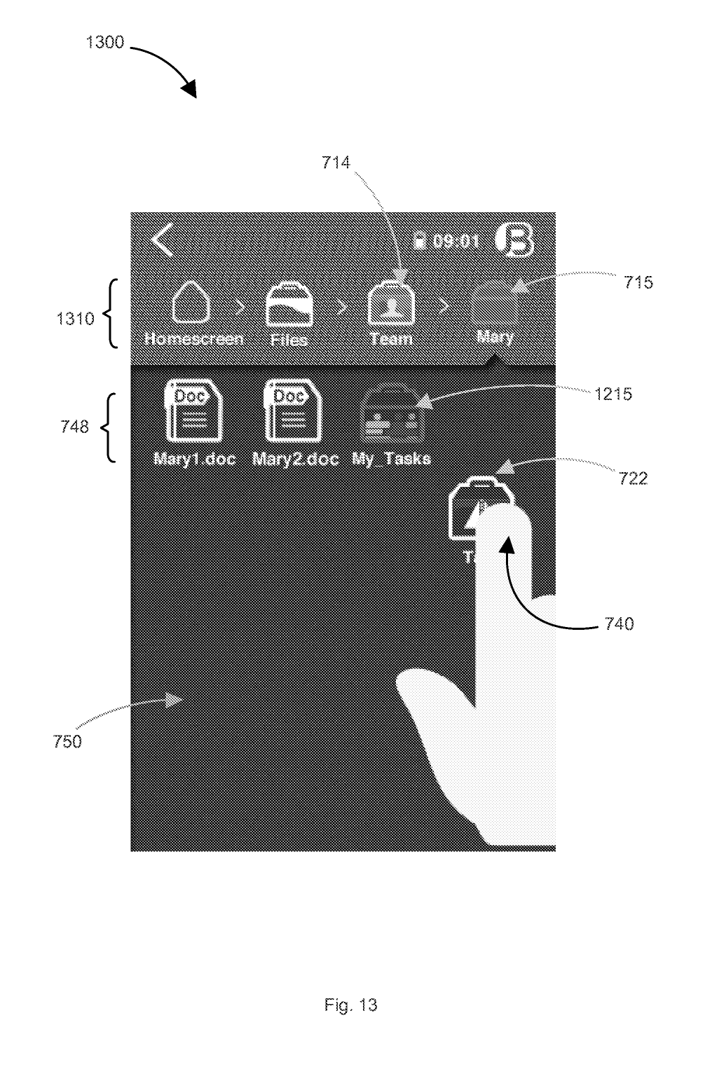

FIG. 9 illustrates the user interface 900 as it appears in the midst of an exemplary single-action gesture to move the folder 722 (Tasks) from its original row of content 720 in the original folder 712 (John) towards another destination, here to its final destination in the folder “My_Tasks” 1215 inside the folder “Mary” 715 that is inside the folder “Team” 714, as seen in FIGS. 12 and 13. Note that when we say in the present application that the selected item 722 is moved from one level to another in the hierarch it is meant that the selected item can be passed up or down through levels in the multilevel hierarchy—even if its final destination is another folder at the same logical level as its original folder. In other words, the user can, with a single gesture (e.g., dragging) pull a selected file or folder from its original place or residence, up or down through the multilevel hierarchy to its final desired place of residence. The folders being nested can spring open to reveal their contents such as shown in FIGS. 7 and 8 above. The user, keeping his or her fingertip or stylus or 740 on the selected item can, without interruption, slide the selected item around the display 750 to its final destination. In some embodiments, as shown in FIG. 9, the selected item 722 is moved by dragging it on top of the desired destination or portal-folder (folder containing the desired destination folder), which will cause the destination or portal-folder to open up and reveal its contents on display 750 to allow continued single-gesture (single action gesture) navigation or movement of the selected item 722.

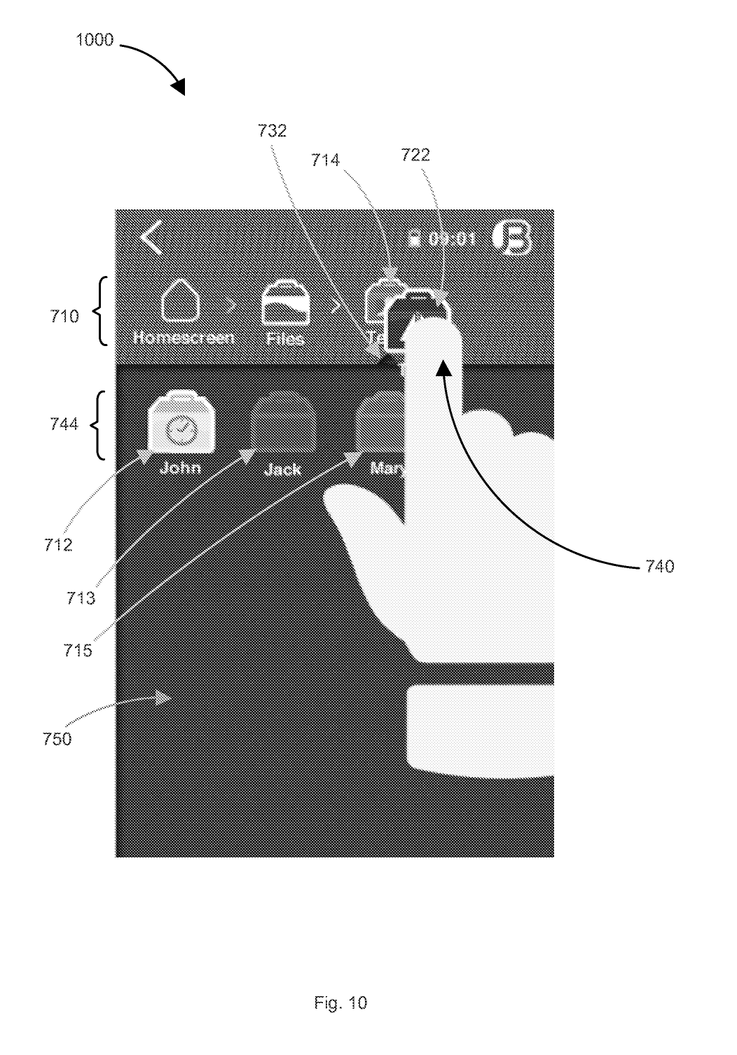

FIG. 10 illustrates the next step in our example of moving selected folder 722 to its final destination in the multilevel hierarchy of folders in user interface 1000. In this example, which is not meant to be limiting, the user interface or application provides that holding the selected item 722 over a destination or portal (through which it can pass to its destination) 714 folder for a predetermined amount of time causes the destination or portal 714 to open on the display 750. The user's fingertip or stylus 740 therefore hold selected item 722 on top of the icon for portal folder 714 in this example (let's say for one second or longer). The portal folder 714 then springs open and the display 750 reveals the contents 744 of the portal or destination folder 714. We see there are several folders inside portal folder 714. There is the folder 712 for team member (John) we discussed earlier, which is the source or original location of selected item 722. There is also a folder 713 for team member Jack, and another folder 715 for team member Mary, all residing in the hierarchy level under the Team folder 714. It can be seen from the pointer, detent or other user interface indicator 732 that the row 744 of content is contained under the folder 714 (Team). The user can now continue his or her gesture to open the selected item as in opening the folder “Mary” 715.

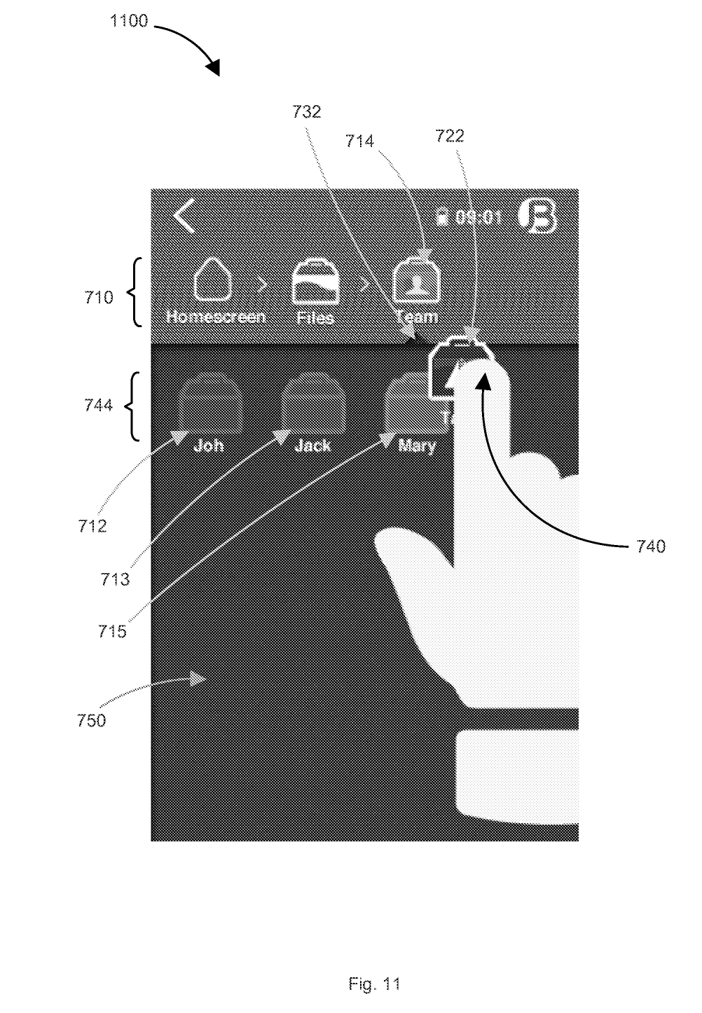

FIG. 11 illustrates the continuing steps of moving selected item 722 towards its target destination folder “My_Tasks” 1215 using the user interface 1100. The user is dragging the selected item 722 onto the folder 715 (“Mary”), which now opens.

FIG. 12 illustrates the continuing action in the user interface 1200 where moving the selected item 722 over the folder 715 (Mary) caused that folder to be revealed, including its contents in row 746, which in turn include a folder of Mary's 1215 (My_Tasks). The row of objects or icons 1210 continues to update itself according to the situation caused by the user's continuing translation of selected item 722 prior to its final release.

FIG. 13 illustrates the next step in a user interface 1300 displaying a multi level hierarchy of items including a folder 715 (Mary) containing a level in said hierarchy shown on a row of objects 748 and having two documents and a folder 1215 (My_Tasks) as described before. The user's continued single action or movement or gesture moves selected folder or object 722 towards its target destination.

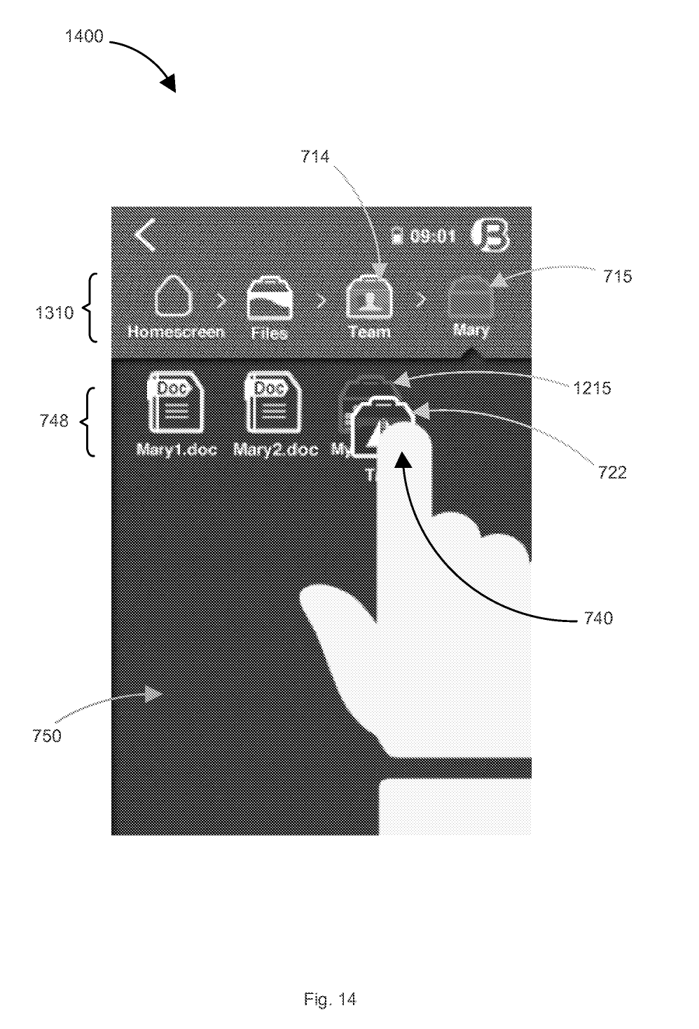

FIG. 14 shows the user moving the selected object 722 onto its final destination target location, which is folder 1215 (My_Tasks) under the folder 715 (Mary) under the folder 714 (Team) in the hierarchy of content on the user's device. The user chooses the destination or target folder 1215 by hovering over it with the selected item 722.

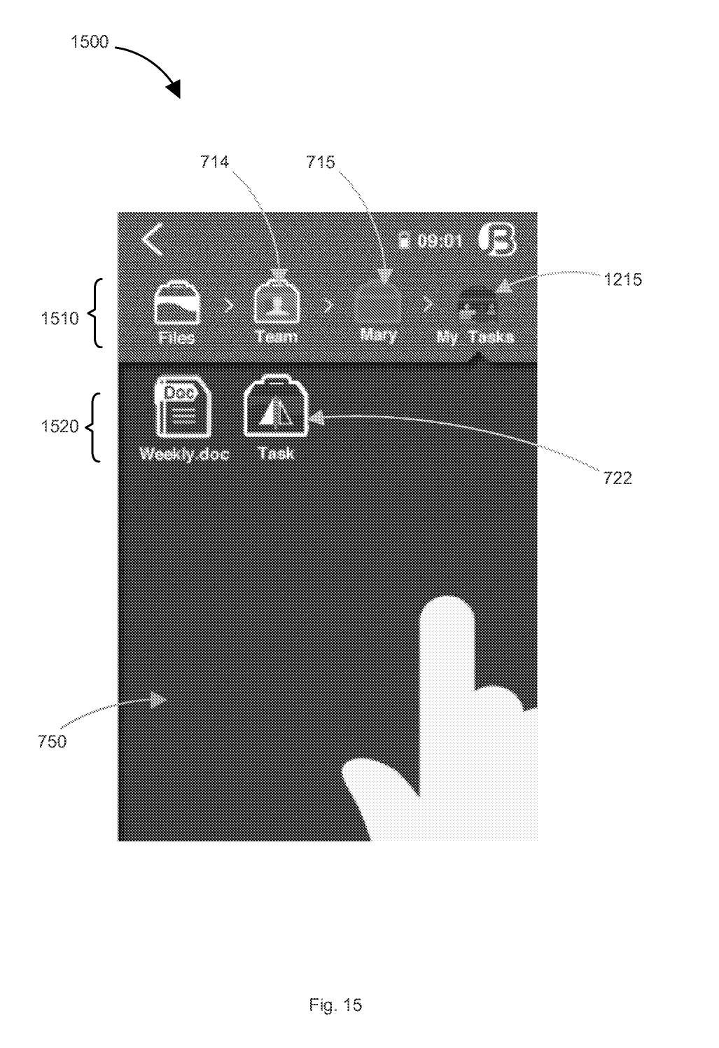

Finally, we see in FIG. 15 that the user has released (lifted his or her fingertip or stylus 740 from the surface of the screen of display 750) thereby placing the selected object 722 (Task) in its final resting place in row 1520 of content within target folder 1215 (My_Tasks) of folder 715 (Mary) of folder 714 (Team), etc. The hierarchy, or a displayed portion thereof is shown in row 1510.

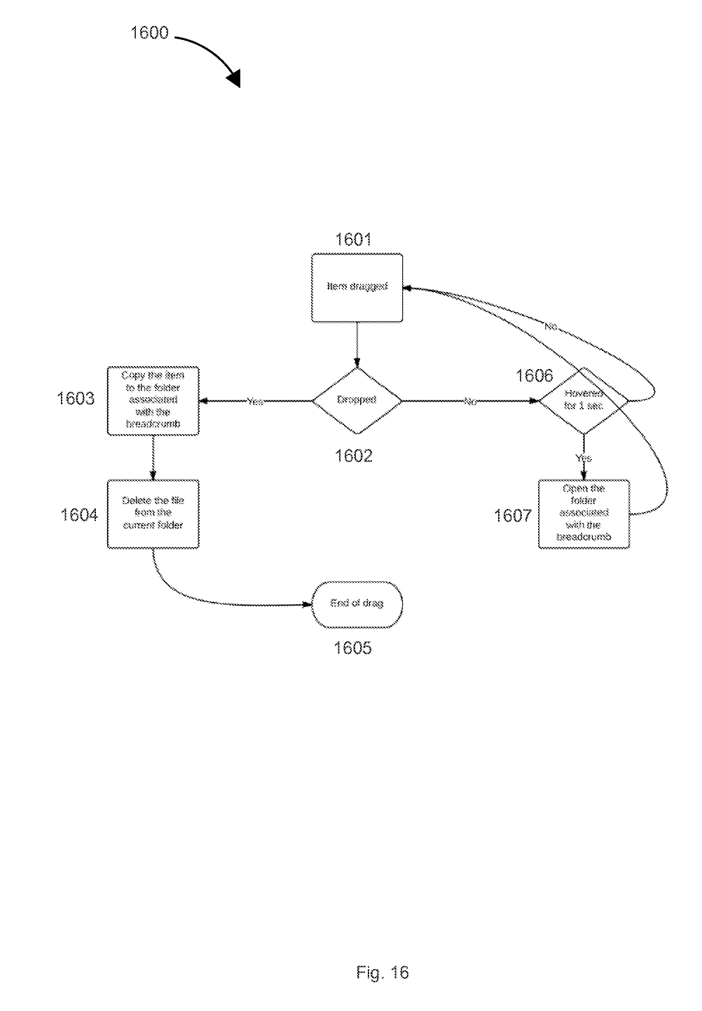

FIG. 16 illustrates a logic flow diagram or flowchart 1600. The process depicted shows how the software and/or hardware accomplishing the present invention operates in an act of moving an item in a mobile type electronic device having multiple hierarchies of stored content.

An item to be dragged can be selected at 1601. The user then either drags and drops the selected item at 1602 or continues moving it on the display screen. If the item is dropped (YES) a copy of the selected item is created in the target or destination folder at 1603 and deleted from its original source folder at 1604, where the operation ends at 1605. If the item is not dropped (NO) the system checks if the user hovers (holds) the item for the requisite amount of time, e.g., greater than 1 second at step 1606. If the item is held there for the requisite delay time, the folder on which the item is held (a destination target or a portal folder) is opened at 1607. If the item selected just quickly passes over (less than one second on) a folder this is not considered a selection and the folder being passed over is not opened or affected.

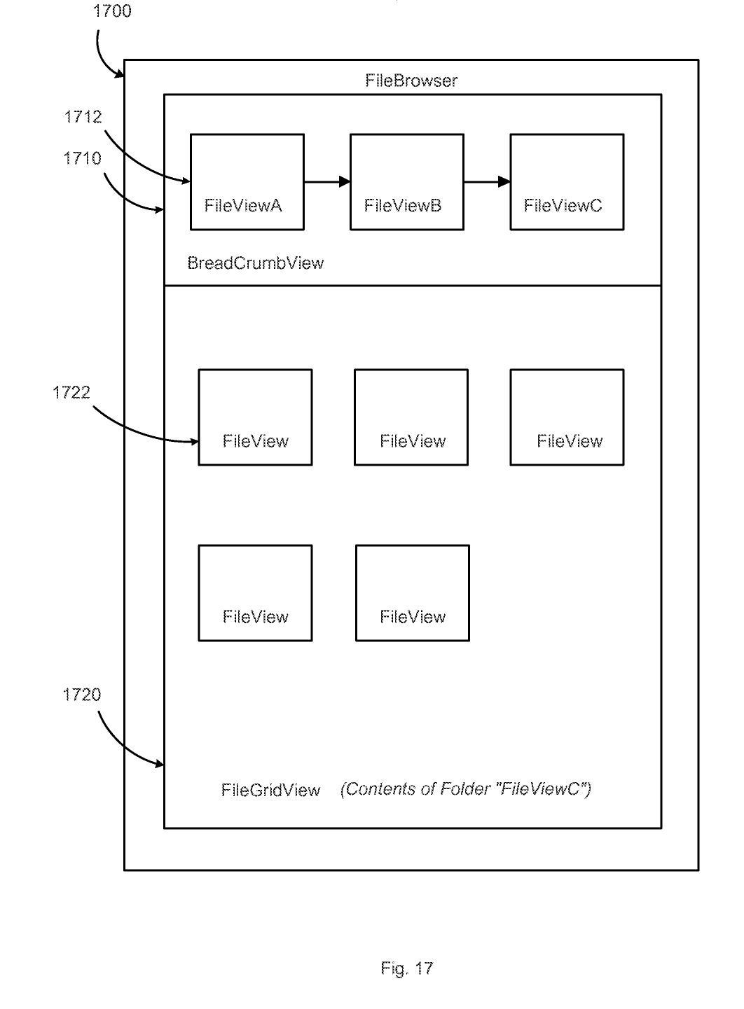

FIG. 17 illustrates an exemplary view of objects in an application including a bread crumb view and a file grid view of electronic objects. In a file browser display 1700 (which may be shown on a portion of an output screen of a device) there is simultaneously shown a breadcrumb view 1710 and a file grid view 1720 of the contents of the file browser. The FileBrowser 1700 is a container view that is the main view that opens upon use of the present application on a device. In some aspects, the present invention supports the following user interface notions and global variables: DragSource identifying the file that the user is touching; DropTarget identifying a destination folder the user is holding a file or folder above; a CurrentFolder is the folder which is currently displayed on the screen; a HoldTimer is a timer that checks how much time a user touches on a specific icon (e.g., of a source folder) that is being held above another icon (e.g., another destination folder) or during a navigate procedure; and PreviousFileView indicating the FileView that the user was holding the dragged icon above on the previous on touch event. When a user holds a folder item above another FileView, this variable is used to check if the user is still on the same FileView at each ontouch (OnTouch) event call. For example, if a user is holding a file item above the FileViewA this variable is used to check if the user is still holding the file item above FileViewA on the next OnTouch event. The touching and holding and dragging actions can be with a finger tip or a stylus device.

The breadcrumb view 1710 is a container view and shows one or more hierarchical levels of a file/folder structure, including a plurality of file views (FileViewA, FileViewB, FileViewC) 1712. The file grid view 1720 is a container view and shows a plurality (all) electronic data objects or file views 1722 within FileViewC (or the lowest FileView selected).

The representations of the information corresponding to the stored objects and groups of objects include file information (FileInfo) such as logical information and the file path for the storage location of the electronic object in the device memory; icons (FileIcon) such as file icon resources of electronic objects represented on the screen; and file names (FileName) displaying the given names of the electronic objects.

In an example, the FileView described herein can include a representation (view) of the file/folders on the screen, including the FileIcon, FileName and FileInfo.

In an example, the BreadCrumbView shows the breadcrumb view 1710 described above including FileView representations 1712 of all the electronic folder objects in this view. The breadcrumb FileViews 1712 can be referred to as BreadCrumbView child views.

In an example, the FileGridView shows the file grid view 1720 described above including FileView representations 1722 of all the electronic file objects in the last folder in the BreadCrumbView 1710. The list of FileViews 1722 may be referred to as FileGridView child views.

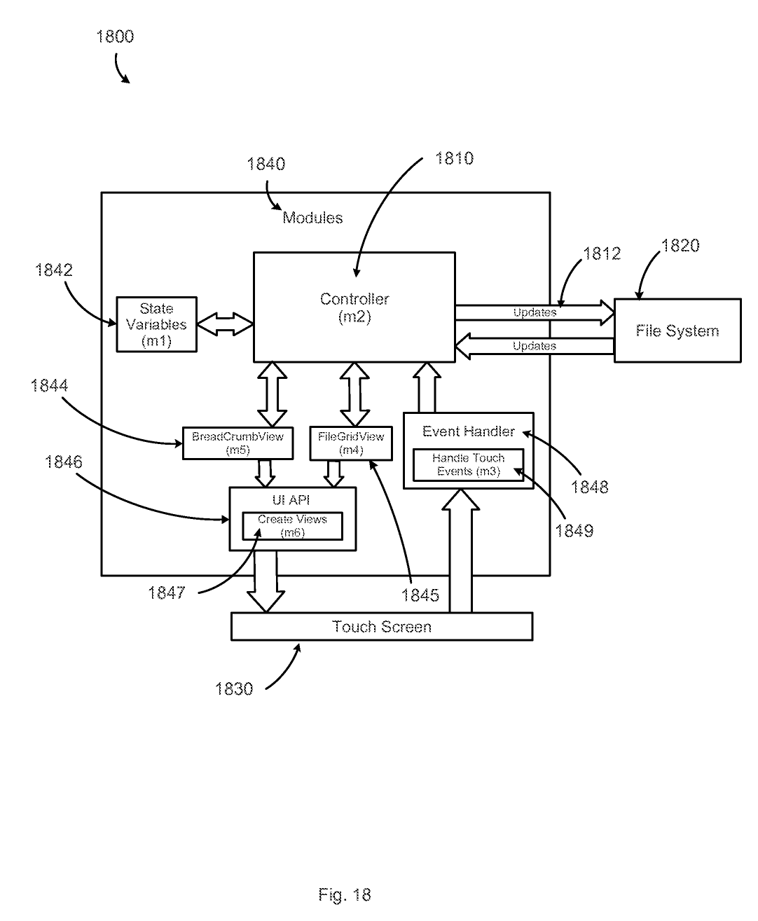

As described herein, a number of events and event handling procedures are defined in the current method. The events are carried out as executable instructions running on suitable hardware as described herein and understood by those skilled in the art. The events take inputs (e.g., user actions, data, other instructions) and process and act on the inputs to generate outputs. Each such processing step is carried out in a suitable processing device or controller as described herein and understood by those skilled in the art. FIG. 18 shows a schematic of a processing system on which the present methods can be carried out. The system 1800 includes a controller 1810, a file system 1820, a touch screen display 1830 and a plurality of modules 1840. The system can be configured in a large variety of ways, and in the illustrated example includes an event handler 1848 capable of handling for example touch events in module m3, a user interface (UI) module 1846 that can for example create views 1847 using module m6, a FileGridView module m4 1845, a BreadCrumbView module m5 1844 and a plurality of state variables in module m1 1842. The controller 1810 and file system 1820 exchange updates 1812 as needed.

In an example of how events are handled, FileGridView::FileView::OnLongClick behaves as follows. If a user long-clicks (clicks for a duration greater than a set duration) on a file or folder icon, FileGridView sets the clicked FileView as a source and sets the StartDrag flag indicating a dragging act. FileGridView sets the OnLongClick listener to each child FileView component on its list.

In another example, BreadCrumbView::FileView::OnClick behaves as follows. Clicking on a folder in BreadCrumbView displays that folder to the user. BreadCrumbView sets the OnClick listener to each child FileView component on its list.

In yet another example, FileBrowser::OnTouch behaves as follows. If StartDrag is set then FileBrowser continuously draws FileViews as long as the user drags it across the screen. OnTouch is called with the following parameters: Action_Down where the user is pressing his finger or stylus device on the screen; Action_Up where the user removes his finger or stylus device from the screen; and Action_Move where the user is moving his finger or stylus device on the screen.

This is an effective and efficient way of displaying the electronic contents of a file/folder structure on a small mobile device screen. Movement within the levels of such a hierarchy is possible by simple clicking and moving of a user's finger or stylus device on a touch screen of a mobile device's display.

Some embodiments refer to “clicking” on an object displayed on a screen. In the context of a mobile type device with a touch sensitive display screen this can mean to touch the screen at a clickable location (such as on a button or on a drawn object on the screen) and the touch of the user's finger or stylus device is translated into a click input to the device. In other instances said touching is done with some force on displays or input devices supporting pressure-sensitive inputs. In yet other instances said clicking involves placing a cursor or pointer or finger of the user or the user's stylus device on a clickable location on the screen, in conjunction with depressing an input button. For example, by moving a trackball that controls a pointer to a desired location on the screen then depressing the trackball or another soft key or physical key indicative of the clicking input.

We will now present one or more scenarios for displaying electronic objects such as files or file folders to a user of a device having a compact interactive display (e.g., a smart phone, tablet, portable computing device, etc.)

In a first scenario, objects are represented and presented to a user. In an aspect, and referring to the modules of FIG. 18, information is displayed visually to the user in breadcrumb and/or file grid views as described earlier. The current folder that is displayed to a user is taken from a global variable called CurrentFolder, which is set by various methods in this scenario. A ‘listener’ is a group of instructions or a module programmed in the device to capture or intercept a predetermined sequence or flag or data or event (e.g., to ‘listen’ for it).

Referring to FIG. 18, FileGridView (using modules m2, m4, m6) creates a list of all files in the current folder; for each file in the list, prepare its corresponding FileView; for each FileView prepared, set OnClick and OnLongClick listeners; and add the contents as child views of FileGridView.

Still referring to FIG. 18, BreadCrumbView (using modules m5, m2, m6) gets the current folder's parent list and adds this to a folder name list. It also adds the name of the current folder to said list (e.g., if the folder is /Android/Download/Recent/Docs, the folder list will be Android.Download.Recent.Docs). For each item in the folder list (except for the first/highest item) place an arrow or pointer icon bitmap at the appropriate location on the screen; prepare the corresponding FileView; for each prepared FileView, set the OnClick listener; and add the contents as child views to BreadCrumbView.

In a second scenario, the user can open the application. Here, a home folder is displayed to the user and the necessary events are set (using modules m1, m2 of FIG. 18). In an aspect, the FileBrowser sets a listener to intercept OnTouch events. Then, it sets the current folder to the home folder. Next, it calls the first scenario (above) to display the contents of a folder to its user.

In a third scenario the user can click on a FileView in the FileGridView described herein. Still referring to FIG. 18, FileGridView acts as follows (using modules m1, m2, m3, m4). It receives the OnClick event on the FileView that the user clicks on; if FileView is a file, it requests the device operating system (OS) to open the selected file; if FileView is a folder, then the current folder is set by checking FileInfo of the FileView, and then the first scenario above is called (displaying contents of a folder to a user).

In a fourth scenario the user can click on FileView in the BreadCrumbView described herein. As depicted on FIG. 18, BreadCrumbView acts as follows (using modules m1, m2, m3, m5). It receives the OnClick event on the FileView that the user selects (clicks on). It then sets the current folder to the FileView's folder by checking the FileInfo of the FileView. Next, it calls the first scenario for displaying the contents of a folder to a user, above.

In a fifth exemplary scenario, the user can navigate a file through a plurality of folders. This scenario describes what happens when a user long-clicks (holds) on an object in order to move it through other folders until the user reaches the destination target folder, places the moved item thereon, and removes his finger or stylus device from the screen to stop the movement of the object. In this scenario, each time the user holds the selected object being moved above the icon of a target destination folder for greater than a predetermined time period. The contents of the destination target folder are displayed and the user can continue navigating to other folders so long as the selected object is maintained or held with the long-click or being continuously held and dragged around from one folder to another. There are two options under the umbrella of this fifth exemplary scenario, which we will refer to here as Scenarios 5.a and 5.b for the sake of illustration. Those skilled in the art will understand that these scenarios are sometimes simplified and are not limiting of the invention, but rather, they are given to indicate the nature of preferred embodiments encompassed hereby. Other scenarios and similar scenarios and processes are also contemplated by the present invention, not each of which is fully detailed in this disclosure, but which are understood by one of skill in the art as being of the same nature or equivalent to those detailed in the present disclosure and drawings.

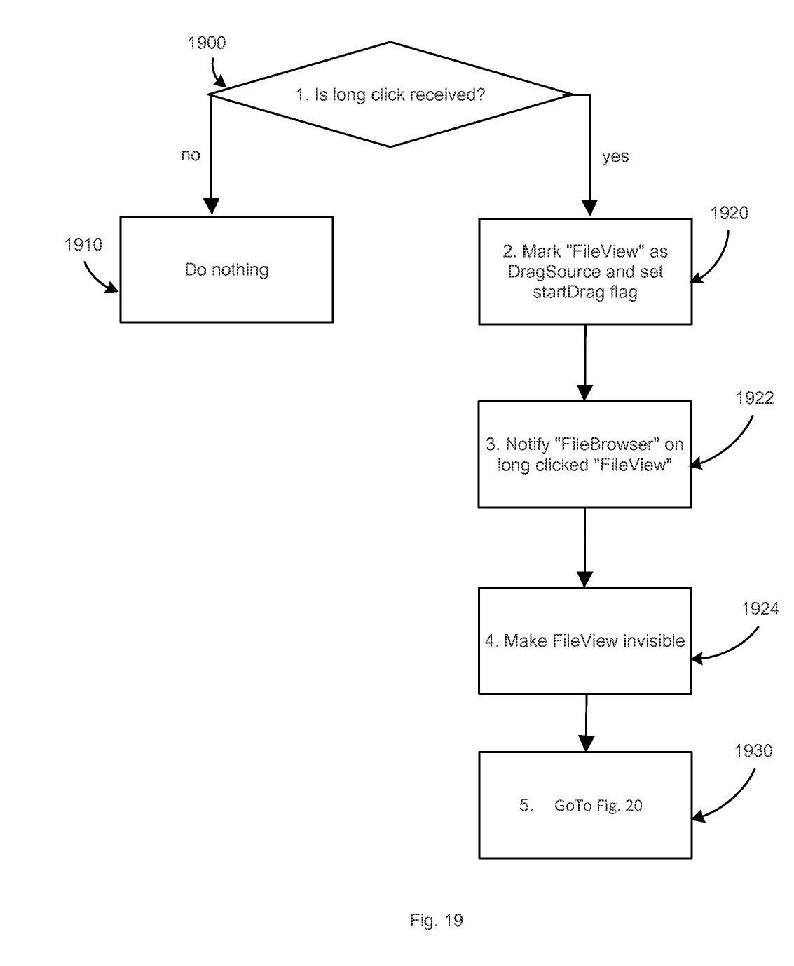

The first option under the fifth exemplary scenario (called Scenario 5.a for simplicity) is that the user maintains or holds the icon of a selected object such as a file and starts dragging it around (using modules m2, m3, m4 and m6). FIG. 19 illustrates the system's operation under this first option of the fifth exemplary scenario. The figure depicts a FileGridView illustrating programmed steps where a user holds a file icon and starts dragging it using the device's touch sensitive display screen.

Referring to FIG. 19, the programmed instructions determine at step 1900 whether a long click was received, i.e., FileGridView listens to a OnLongClick on each FileView feature. Meaning, the system monitors or listens for input by the user and if such input represents a long interval clicking event exceeding a pre determined length of time (press-and-hold, or a long click). If not, then nothing is done (1910). If a long click is detected, then FileView is marked as the DragSource (the source from which something is to be moved) by activating the StartDrag flag at step 1920. FileBrowser is notified of the long-clicked FileView at step 1922 and the FileView is made invisible at step 1924, and the system can draw a representation of the dragged item being moved or dragged on the screen. Finally, at step 1930 the process moves to the next Figure and text below.

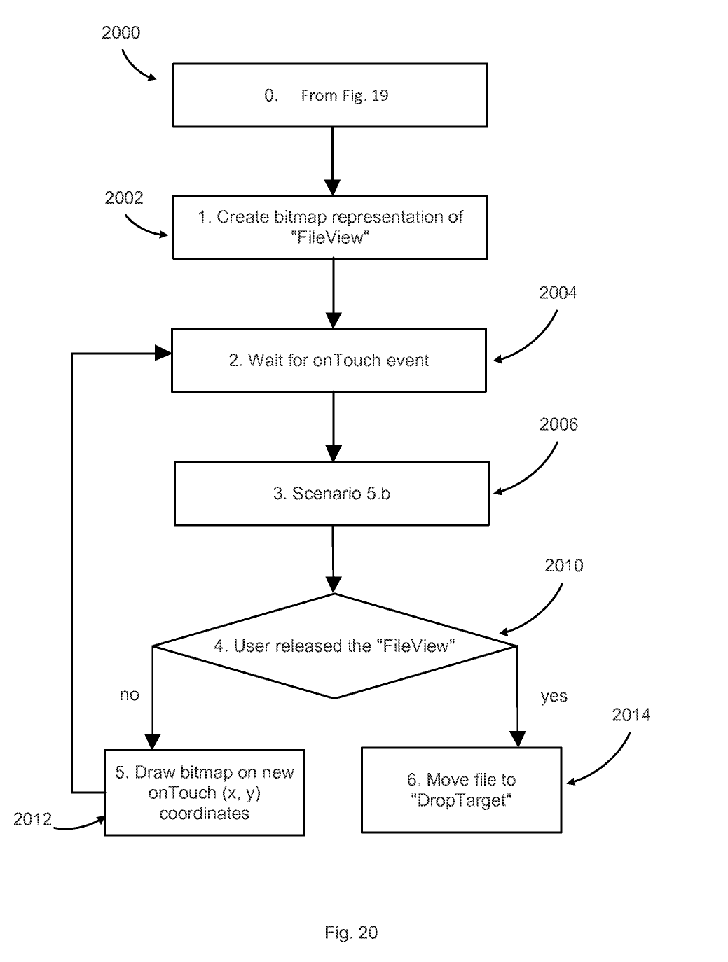

FIG. 20 illustrates the exemplary second option of the fifth exemplary scenario. This process starts with the previously described FIG. 19 and text at step 2000. When receiving a FileView from FileGridView, the FileBrowser generates a representation (e.g., bitmap or similar image) to represent the FileView at step 2002. The user can interact with such a generated FileView on the touch sensitive display, e.g., to drag it or click it or look within it. The system waits for a OnTouch event at step 2004. Each time this OnTouch event is called by the device, the following steps take place. The system determines when and how to display the content of the folder that the user is holding a file icon above (as described earlier) at step 2006. At step 2010, the system checks if the user has stopped touching the device screen and thereby released the FileView. If yes, the file is moved to the DropTarget at step 2014, otherwise, a fresh bitmap or image of the representation of the moved object is drawn on the new OnTouch coordinates, e.g., the (x, y) coordinates touched, then return to step 2004 and wait for further OnTouch events. If the user releases the FileView, then move the DragSource to the target FileView identified in step 2004. If the user drags the DragSource object to an empty spot on the screen (not over a folder) then the DragSource object is moved to the currently displayed folder in the FileGridView. Finally, FileGridView is notified to update the StartDrag flag to “False.”

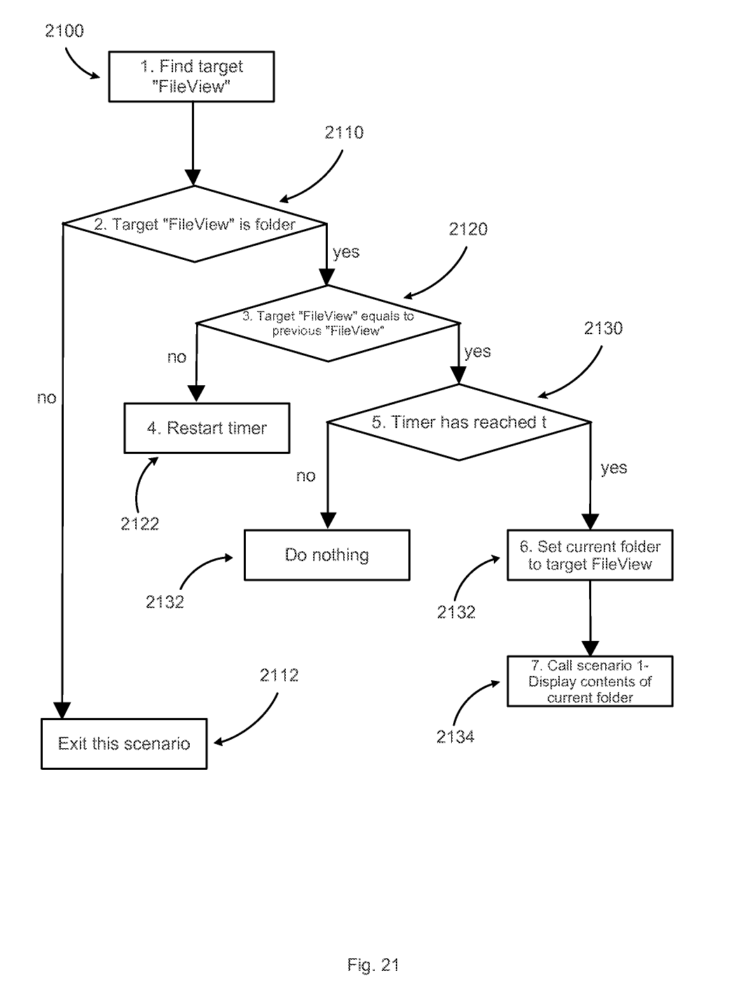

Now referring to FIG. 21, which shows an exemplary method according to the present invention. The system finds the target FileView at step 2100. If the target FileView is not a folder then this process does not apply. If the target FileView is a folder per step 2110, then the system determines at step 2120 whether the target FileView is the same as the previous FileView. If it is not then the system resets or restarts a counter/timer at step 2122. If the target and previous FileView are the same then it checks whether the counter/timer have reached a predetermined time t at step 2130. Nothing is done 2132 if not. But if the counter/timer t has been reached the system sets the current folder to the target FileView at 2132. Finally, at step 2134 the system displays the contents of the current folder as described above. The user can continue navigating as well.

In some aspects a folder is a special type of file. For general purposes in the present context a folder and a file are examples of information objects. The FileViews above can be implemented by programming instructions using a programming language, and running, compiling and executing the instructions from a digital memory storage device such as a RAM or other computer memory module. The FileViews cause a processing circuit such as a general purpose processor or graphics processor to generate outputs to create the visible icons of the information objects (e.g., icons of files and folders) on a touch-sensitive display of a mobile computing device or smartphone, tablet, etc. The coordinates (e.g., Cartesian horizontal/vertical) coordinates that a user touches with his or her fingertips on the touch-sensitive screen are translated into events indicative of which icon is being selected and when the finger (or stylus device) is moved to another set of coordinates. Therefore, a source coordinate set and a destination coordinate set can be determined in a movement of a user's finger or device on the screen, as well as the duration of the pressing or touching of a certain coordinate or location on the screen to indicate to the system whether the user has performed an extended long-click (touch and hold) event. In an example, the length of a long touch is at least one second counted on a timer or counter. A computer-readable memory can store the programmed instructions.

The present systems and methods will increase the usefulness of the devices on which they are implemented. For example, by being able to quickly and easily move objects stored in the personal computing device of a user, including to move a file from one source folder up through a multilevel folder hierarchy, across to another parent folder with a multi-level hierarchy, then down into the destination folder hierarchy to a destination folder. The present disclosure can be implemented in a relatively modest computing device that is portable and has a limited (e.g., small) screen area, which is limited to substantially a single active application window. So, unlike previous systems which allow manipulation of stored files by opening multiple graphical windows on a computer screen, the present system can present the Breadcrumbs view of the hierarchy of available source and destination folders as well as the contents of a folder in Gridview all on a same application window. The user can with one finger, explore and manipulate and relocate stored items all on this one open application screen on the small screen device.

Of course the above example is provided as a detailed illustration of the operation and construction of the system of the invention. Many of the exemplary features of these embodiments can be revised or alternates chosen to achieve a same or equivalent end. Therefore, the invention is not limited by the above examples and those skilled in the art are expected to find custom implementations suiting their applications and ends along these lines.

Those skilled in the art would appreciate that any type of electronic or digital object capable of being defined and stored in a storage device such as computer memory may be manipulated within the portable or mobile electronic device as described above. Also, a plurality of levels in the hierarchy can allow for nested folders and groups of objects to be stored therein. Each object or group of objects or folder can be represented by a name and a graphical icon with which a user may interact on the single-window user interface display. In this way it is not necessary to have sophisticated computing resources or operating systems that present multiple window user interface in the mobile electronic device. Rather the present user interface is very simple to use and allows one movement or gesture by a user to reorganize the contents of the mobile electronic device, for example moving a stored object from one location in the hierarchy of directories to another level in said hierarchy. The selected object can traverse up and down a hierarchy using a single gesture of a user (e.g., a drag and drop gesture), passing up or down through any number of levels containing information objects (files, folders) to its final destination.

We claim:

1. A method for representing information in a mobile electronic device having a touch-sensitive single-window user interface capable display, comprising:
organizing a plurality of information objects stored in said mobile electronic device according to a multilevel hierarchy, whereby each of said information objects occupies some level in said hierarchy;
presenting on said display, in said single-window user interface, an inline series of graphical icons, each icon representing a corresponding one the group of information objects, and arranging each of the icons on said display according to its object's level in said hierarchy;
using a single gesture by a user, whereby said gesture comprises a user interaction with a surface of said display, selecting a selected one of said information objects by way of its graphical icon, and translating the graphical icon of said selected information object in a movement corresponding to said user's gesture, thereby moving the icon of said selected information object from a first level in said hierarchy to a second level in said hierarchy.

2. The method of claim 1, said user interaction comprising inputting and accepting contact with a touch-sensitive element of said display.

3. The method of claim 1, further comprising physically reorganizing said plurality of information objects stored in said mobile device to store them according to a new order based on said user's gesture.

4. The method of claim 1, further comprising logically reorganizing said plurality of information objects stored in said mobile device by updating a logical relationship between said plurality of information objects based on said user's gesture.

5. The method of claim 1, said gesture further requiring a user to interact with said graphical icon of the selected object for a predetermined length of time prior to translating said graphical icon.

6. The method of claim 1, further comprising presenting on said display a graphical listing of contents of a folder that is selected by said user.

7. The method of claim 1, further comprising presenting stored content in a level of said hierarchy as an inline row of icons on said display.

8. A mobile electronic device having a touch-sensitive graphical display unit, data storage unit and processing unit, the device comprising:
said data storage unit that stores a plurality of information objects in a multilevel hierarchical structure;
said touch-sensitive graphical display unit comprising an interactive screen that presents graphical representations of stored information objects and that responds to interactive gestures of a user and affects a status of information on said device responsive thereto; and
said processing unit that executes machine-readable instructions including instructions to present a graphical user interface on said graphical display, and that executes machine-readable instructions to accept user interface inputs from a user of said device through said graphical display unit including accepting signals responsive to a single user interface gesture translate a graphical icon of a selected information object displayed on said graphical display in a movement corresponding to said user's gesture, thereby moving the icon of said selected information object from a first level in said hierarchy to a second level in said hierarchy and displacing data stored in said data storage unit corresponding to said movement of said icon.

9. The device of claim 8, said graphical representations including breadcrumb icon representations corresponding to respective stored information objects and arranged in an inline row for a given level of said hierarchy.

10. The device of claim 8, further comprising an event handler module that detects and responds to events through a user interface of said device.

11. The device of claim 10, said event handler module comprising a touch events module that detects and responds to display touching events.

12. The device of claim 8, further comprising a counter or timer module that detects a length of time that a touch event continues for and responds thereto in a long click or long-touch response if said touch event continues for a duration greater than a predetermined length of time.
